(19) United States
(12) Patent Application Publication
(10) Pub. No.: US 2002/0158731 A1
(43) Pub. Date: Oct. 31, 2002

(54) CIRCUIT BREAKER ACTUATOR MECHANISM

(76) Inventors: James Lawrence Rosen, West Hartford, CT (US); Roger Neil Castonguay, Terryville, CT (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 09/681,561

(22) Filed: Apr. 30, 2001

(51) Int. Cl. H01H 9/20

(52) U.S. Cl. 335/167

(57) ABSTRACT

A trip actuator includes a trip arm configured to provide an actuating force for unlatching the circuit breaker operating mechanism and an actuator mechanism for changing the state of the circuit breaker accessory. The actuator mechanism includes a first lever biased to rotate in a first direction about a first axis and a latch assembly releasably restraining the first lever from rotating in the first direction. The latch assembly includes a second lever and a slide. The slide is operably coupled to the second lever, and the slide releasably restrains the first lever. The second lever moves the slide to release the first lever when the actuating force is applied to the second lever.

### BACKGROUND OF INVENTION

Modern circuit breakers rely on electronics for the detection of potentially damaging over-current conditions. These electronics, known as trip units, sense current in a protected portion of an electrical distribution circuit and initiate a trip signal if the sensed current indicates an over-current condition. In such circuit breakers, an electromechanical actuator, known as a trip actuator or trip mechanism, is used to unlatch a circuit breaker operating mechanism in response to the trip signal. The operating mechanism is a spring-operated linkage arrangement. When unlatched, the operating mechanism separates a pair of main contacts to stop the flow electrical current to the protected portion of the distribution circuit.

Circuit breakers employing electronic trip units and trip actuators are often fitted with additional means for detecting fault conditions in the distribution circuit and unlatching the circuit breaker operating mechanism in response to these fault conditions. For example, a circuit breaker may be fitted with a ground fault module that detects a ground fault and, in response to the detection of a ground fault, unlatches the operating mechanism to separate the main contacts. In another example, a mechanical override system can be built into the circuit breaker. A mechanical override system mechanically unlatches the operating mechanism when the main contacts in any single pole of a multi-pole circuit breaker are separated due to an instantaneous overcurrent.

During the operation of the circuit breaker, it is desirable to have a mechanism that allows a technician or operator to determine when the contacts have been separated due to a fault condition in the electric circuit to which the circuit breaker is attached. As such, circuit breakers are fitted with accessories, such as bell alarm switches, that enable remote or local indication that the contacts have been separated.

Typically, a circuit breaker will rely on the force of the trip actuator to activate the accessory. However, in circuit breakers fitted with more than one means for unlatching the circuit breaker operating mechanism, the accessory will not indicate that the contacts have been opened when the operating mechanism has been unlatched by a means other than the trip actuator. Moreover, relying on the actuating force of the trip actuator to activate the accessory reduces the force available for unlatching the operating mechanism and slows the movement of the trip actuator. As a result, the time delay from detection of an overcurrent condition to the separation of the main contacts is increased.

### SUMMARY OF INVENTION

The above discussed and other drawbacks and deficiencies of the prior art are overcome or alleviated by a trip mechanism with an accessory activating mechanism. In an exemplary embodiment of the invention, the trip actuator includes a trip arm configured to provide an actuating force for unlatching the circuit breaker operating mechanism and an actuator mechanism for changing the state of the circuit breaker accessory. The actuator mechanism includes a first lever biased to rotate in a first direction about a first axis and a latch assembly releasably restraining the first lever from rotating in the first direction. The latch assembly includes a second lever and a slide. The slide is operably coupled to the second lever, and the slide releasably restrains the first lever. The second lever moves the slide to release the first lever when the actuating force is applied to the second lever.

### BRIEF DESCRIPTION OF DRAWINGS

Referring to the exemplary drawings wherein like elements are numbered alike in the several Figures:

FIG. 1 is a perspective view of a circuit breaker including a trip actuator and accessory;

FIG. 2 is an exploded perspective view of the circuit breaker of FIG. 1;

FIG. 3 is a perspective view of the trip actuator and operating mechanism of FIG. 2;

FIG. 4 is a side view depicting the general operation of the circuit breaker operating mechanism of FIG. 3;

FIG. 5 is a perspective view of the trip actuator of FIG. 3 in a reset state;

FIG. 6 is a side view of the trip actuator of FIG. 3 in a latched state;

FIG. 7 is a side view of the trip actuator of FIG. 3 in an unlatched state;

FIG. 8 is a side view of an indicator mechanism of the trip actuator of FIG. 3 in a latched state;

FIG. 9 is a top view of the indicator mechanism of FIG. 8 in a latched state;

FIG. 10 is a top view of the indicator mechanism of FIG. 8 in an unlatched state; and

FIG. 11 is a side view of the indicator mechanism of FIG. 8 in an unlatched and partial reset state.

### DETAILED DESCRIPTION

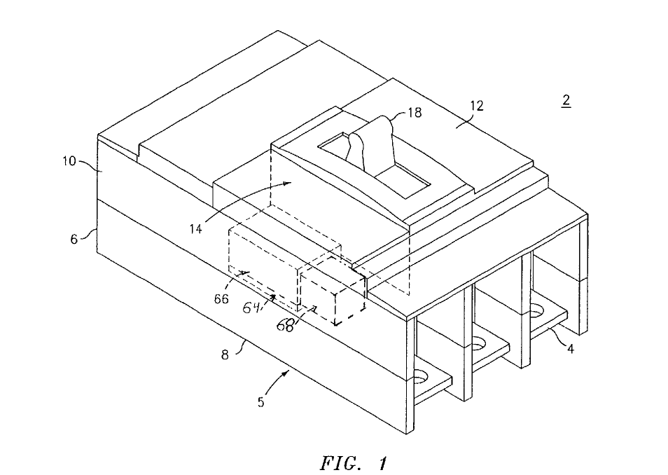

A top perspective view of a molded case circuit breaker 2 is provided at FIG. 1. Molded case circuit breaker 2 is generally interconnected within a protected circuit between multiple phases of a power source (not shown) at line end 4 and a load to be protected (not shown) at load end 6. Molded case circuit breaker 2 includes a housing 5 with a base 8, a mid cover 10 and a top cover 12. An operating handle 18 passes through top cover 12 and interconnects with a circuit breaker operating mechanism 14. A trip actuator 66 is generally positioned within mid cover 10. Also positioned within mid cover 10 is an accessory 68 that is operated between discrete positions (e.g., on and off) by an indicator mechanism 64 within trip actuator 66.

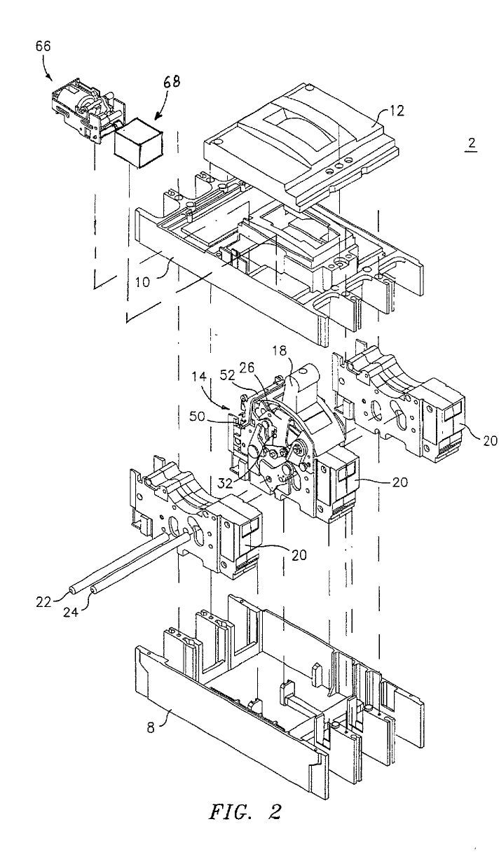

Referring now to FIG. 2, an exploded view of molded case circuit breaker 2 is provided. A series of circuit breaker cassettes 20 are generally well known and may be, for example, of the rotary type. Circuit breaker cassettes 20 are seated approximately upstanding within base 8, and one of the cassettes 20 includes operating mechanism 14 positioned thereon. One cassette 20 is provided for each phase of the electrical distribution circuit. Each cassette 20 includes one or more contact pairs therein for passage of current when the contacts are closed and for preventing passage of current when the contact pairs are opened. Each cassette 20 is commonly operated by a first bar 22 and a second bar 24 that interface with the internal mechanisms of cassettes 20 and with operating mechanism 14 such that operating mechanism 14 operates all cassettes 20. It is contemplated that the number of phases, or specific type of cassette utilized, can vary according to factors including, but not limited to, the type of load circuit being protected and the type of line input being provided to the circuit breaker 2.

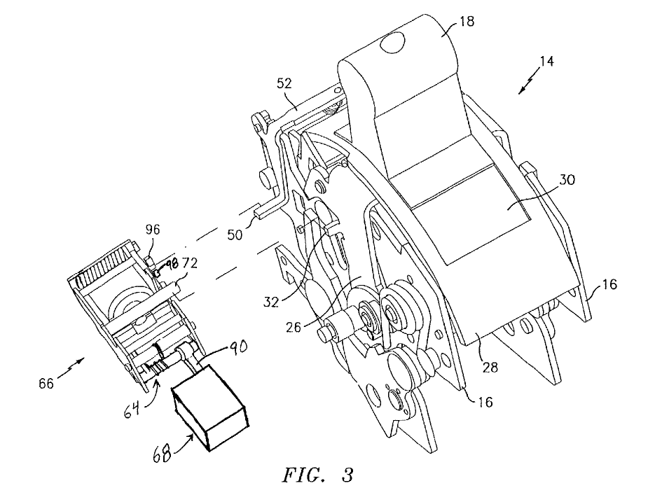

Referring to FIG. 3, circuit breaker operating mechanism 14 includes a frame 16 having spaced apart sidewalls. An operating handle-yoke 26 generally fits over frame 16. Operating handle 1 8 is interconnected with operating handle-yoke 26. Operating mechanism 14 includes an operating mechanism cover 28 with a handle opening 30 formed therein allowing operating handle 1 8 to pass therethrough. Handle-yoke 26 includes a reset tab 32 depending generally perpendicularly therefrom to allow interface with trip actuator 66, and more specifically to interact with a reset tab 72 of trip actuator 66. Frame 1 6 includes a secondary latch 52 pivotally secured thereto. Secondary latch 52 includes a secondary latch tab 50 depending generally perpendicularly therefrom. Secondary latch tab 50 interfaces with a trip paddle 96 extending from trip actuator 66. Trip paddle 96 interfaces with an indicator actuating paddle 98 operatively connected to indicator mechanism 64 of trip actuator 66. Indicator mechanism 64 includes a lever 90 pivotally disposed within trip actuator 66. Lever 90 interfaces with accessory 68.

Upon assembly, trip actuator 66 is positioned such that trip paddle 96 is adjacent to latch tab 50, reset tab 72 is adjacent to reset tab 32, and lever 90 is adjacent accessory 68. This is generally accomplished by seating trip actuator 66 alongside operating mechanism 14 and proximate accessory 68 within mid cover 10 (FIGS. 1 and 2).

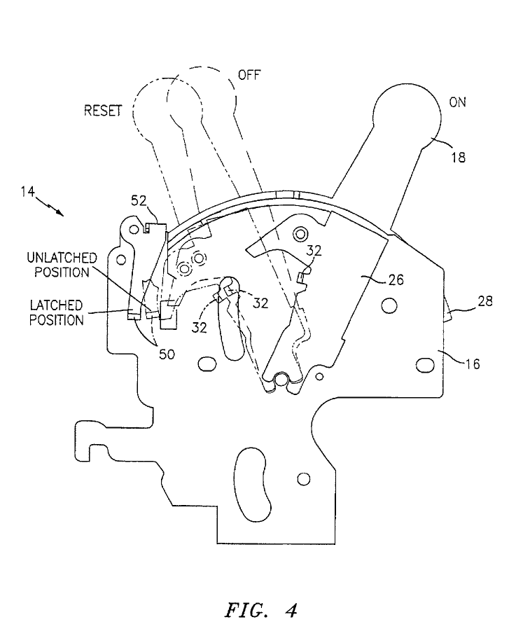

Referring to FIGS. 3 and 4, the operation of the circuit breaker operating mechanism 14 will be generally described. FIG. 4 shows the operating mechanism 14 in three discrete positions: the “ON” position, the “OFF” position and the “RESET” position. Upon activation of trip actuator 66, trip paddle 96 will be displaced generally in a forward direction (toward reset tab 72) and will contact latch trip tab 50 and indicator actuating paddle 98. In response to the forward displacement by trip paddle 96, trip tab 50 moves from a “Latched” position to an “Unlatched” position as shown in FIG. 3. This will release latch 52 allowing operating mechanism 14 to move from the “ON” position to a “TRIPPED” position (not shown), opening the set of circuit breaker contacts (not shown). In the “TRIPPED” position, handle 18 is located between the “ON” and “OFF” positions shown. Displacement of the indicator actuating paddle 98 by the trip paddle 96 will unlatch indicator mechanism 64, causing lever 90 to change the state of accessory 68.

Before operating handle 18 may be returned to the quiescent operation position (i.e., “ON”), circuit breaker operating mechanism 14, trip actuator 66, and indicator mechanism 64 must be reset. This is accomplished by manually rotating operating handle 18 in the counter-clockwise direction (with respect to the view shown in FIG. 4) against the forces of one or more springs (not shown) to the “RESET” position, thereby moving the secondary latch 52 of operating mechanism 14 from the “Unlatched” position to the “Latched” position. The motion of operating handle 18 rotates reset tab 32, thereby driving reset tab 72 towards trip paddle 96 to reset trip actuator 66 and indicator mechanism 64, as will be described in further detail hereinafter.

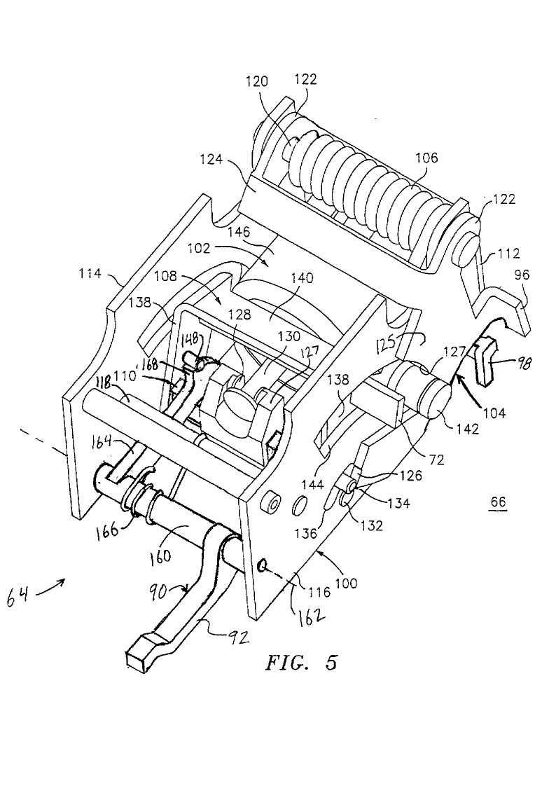

Referring to FIG. 5, a perspective view of trip actuator 66 is shown. Trip actuator 66 includes a frame 100, an electromechanical device such as a flux shifter 102, a trip arm 104, a trip spring 106, a reset lever 108, a latch 110, and indicator mechanism 64. Frame 100 includes a back wall 112 with two sidewalls 114, 116 depending substantially perpendicular therefrom. The sidewalls 114, 116 extend substantially parallel to each other, and are joined by frame pins 118 that extend from side wall 114 to side wall 116. Frame 100 is preferably formed from a single plate of metal.

Trip arm 104 is hingedly secured to sidewalls 114, 116 by a trip arm pivot 120, which extends from side wall 114 to side wall 116. Trip arm 104 includes two hinge portions 122 which accept trip arm pivot 120, and a hinge support portion 124 that extends between hinge portions 122. Trip arm 104 also includes a latch portion 125 that extends downwardly from support portion 1 24 and along the outside of side wall 116. Trip paddle 96 depends substantially perpendicularly from latch portion 125. A latch surface 126 is formed on an edge of latch portion 125 opposite the trip paddle 96. Trip arm 104 is preferably formed from a single plate of metal.

Trip spring 106 is shown as a torsion spring disposed around trip arm pivot 120. One end of trip spring 106 is secured to the circuit breaker mid cover 10 (FIG. 2), while the other end is positioned beneath the hinge support portion 124 of the trip arm 104. When installed in mid cover 10, trip spring 106 acts to bias trip arm 104 in the clockwise direction, as shown in FIG. 5.

Latch 110 is formed as a substantially rectangular shaft having a boss 127 disposed on a central portion thereof. A slot 128 formed in boss 127 accepts the head of a plunger 130, which extends from flux shifter 102. The ends of latch 110 are pivotally secured to frame sidewalls 114 and 116 by a latch pivot 132. A latch pin 134 is secured to an end of latch 110, and extends from latch 110 through an arcuate slot 136 disposed in side wall 116. Latch pin 134 is arranged to interact with the latch surface 126 of trip arm 104 in a manner described hereinbelow.

Reset lever 108 includes side arms 138 that extend from a central support 140. Side arms 138 extend along side walls 114, 116 and are pivotally secured to side walls 114, 116 by latch pivot 132. Reset tab 72 and a reset pin 142 depend substantially perpendicularly from side arm 138 proximate side wall 116. Reset tab 72 and reset pin 142 extend through an arcuate slot 144 formed in sidewall 116. One side arm 138 includes a reset pin 148 depending therefrom and extending towards the other side arm 138.

Flux shifter 102 is an electromechanical device mounted to rear wall 112 of the frame 100. The construction and operation of flux shifter 102 is known in the art and is similar in operation to that described in U.S. Pat. No. 5,453,724. Flux shifter 102 includes the plunger 130, which slidably extends from a body 146. Plunger 130 is releasably secured by a magnet (not shown) within body 146. Flux shifter 102 is arranged to receive a triggering signal (e.g., a trip signal) from an electrical device (e.g., a trip unit). Upon receipt of the triggering signal, a coil (not shown) in the flux shifter 102 shunts out the magnet, and the plunger 130 is released from the magnet. Once released by the magnet, the plunger 130 is free to extend outward from the body 146.

A portion of indicator mechanism 64 is visible in FIG. 5. As can be seen from FIG. 5, indicator mechanism 64 includes lever 90 and a torsion spring 166. Lever 90 includes an axle 160 extending from side wall 114 to side wall 116. Axle 160 is configured to rotate about its longitudinal axis 162. Lever 90 also includes a release arm 164, which extends radially from axle 160 proximate side wall 114, and an actuating arm 92, which extends radially from axle 160 proximate side wall 116 and in a direction generally opposite from release arm 164. Torsion spring 166 is disposed around axle 160, and extends from release arm 164 to a frame pin 118. Torsion spring 166 biases lever 90 in a counter-clockwise direction around longitudinal axis 162 (with respect to the view shown in FIG. 5).

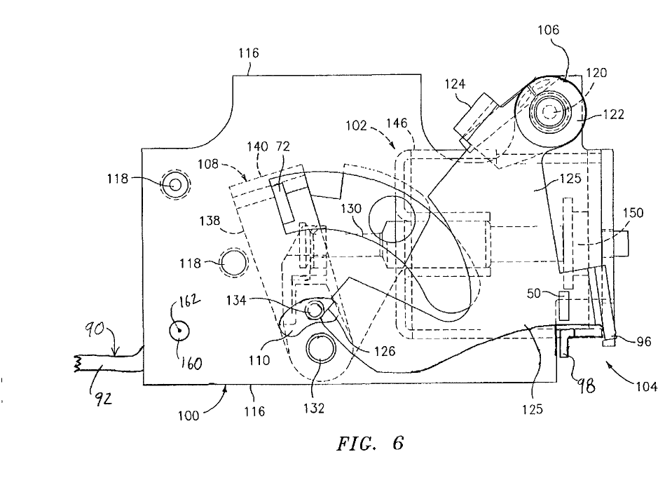

Referring to FIGS. 5, 6, and 7, operation of the trip actuator 66 will now be described. FIG. 6 shows the trip actuator 66 in a latched and ready to operate state. In this state, the trip spring 106 is loaded to bias the trip arm 104 in a clockwise direction about the longitudinal axis of trip arm pivot 120. The latch surface 126 of the trip arm 104 acts against the latch pin 134. The latch 110 is held in an upright position by the plunger 130, and the plunger 130 is held in tension by a magnet 150 disposed in the body 146 of the flux shifter 102. The force of the plunger 130 on the latch 110 holds the latch 110 in the upright position against the force of the trip arm 104.

When a trip (triggering) signal is provided to the flux shifter 102, the coil (not shown) in the flux shifter 102 shunts out the magnetic circuit, releasing the plunger 130. With the tension on plunger 130 removed, the trip arm 104 will drive the latch pin 134, causing the latch 110 to rotate counterclockwise about the latch pivot 132. As the latch 110 and trip arm 104 rotate about their respective pivots 132, 120, the latch pin 134 slides off the latch surface 126, fully releasing the trip arm 104 and allowing the trip paddle 96 to move towards and into contact with the secondary latch tab 50 and the indicator actuating paddle 98. Movement of the actuating paddle 98 unlatches indicator mechanism 64, allowing lever 90 to rotate in a counter-clockwise direction about axis 162 under the force of torsion spring 166, as will be described in further detail hereinafter.

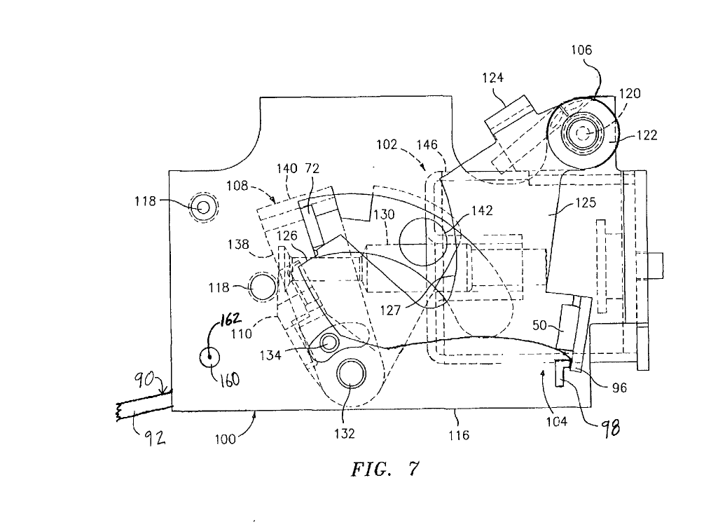

The trip actuator 66 comes to rest in the tripped released state shown in FIG. 7, where the latch 110 is prevented from rotating further in the counterclockwise direction by contact with the frame pin 118 and the trip arm 104 is prevented from rotating further in the clockwise direction by contact with the reset tab 72.

The trip actuator 66 is reset (i.e. placed in the latched and ready to operate state of FIG. 6) by the reset motion of the operating handle 18. As the operating handle 18 is rotated to the “RESET” position, as described with reference to FIG. 4, the reset tab 32 of the operating handle 18 pushes the reset tab 72 of the trip actuator 66. This action causes the reset lever 108 to pivot in a clockwise direction about latch pivot 132 and causes reset pin 142 to contact the reset surface 127 of the trip arm 104. Trip arm 104 is thus rotated in the counterclockwise direction. As the trip arm 104 is driven counterclockwise, the latch pin 134 is released from beneath the latch surface 126 allowing the plunger 130 to be drawn back into the body 146 of the flux shifter 102 by the magnet 150 (which is no longer being shunted by the triggering signal). As the plunger 130 is drawn back into the body 146, the plunger 130 causes the latch 110 to rotate to its upright position. With the latch 110 in its upright position, the trip arm 104 becomes latched, and the trip actuator 66 is in the latched and ready to operate state of FIG. 6.

As can best be seen in FIG. 5, as the reset lever 108 pivots in a clockwise direction about latch pivot 132, pin 148 contacts a camming surface 168 formed on release arm 164. As pin 148 traverses camming surface 168, lever 90 is rotated in a clockwise direction around longitudinal axis 162 until indicator mechanism 64 is in the latched and ready to operate state, as will be described in further detail hereinafter.

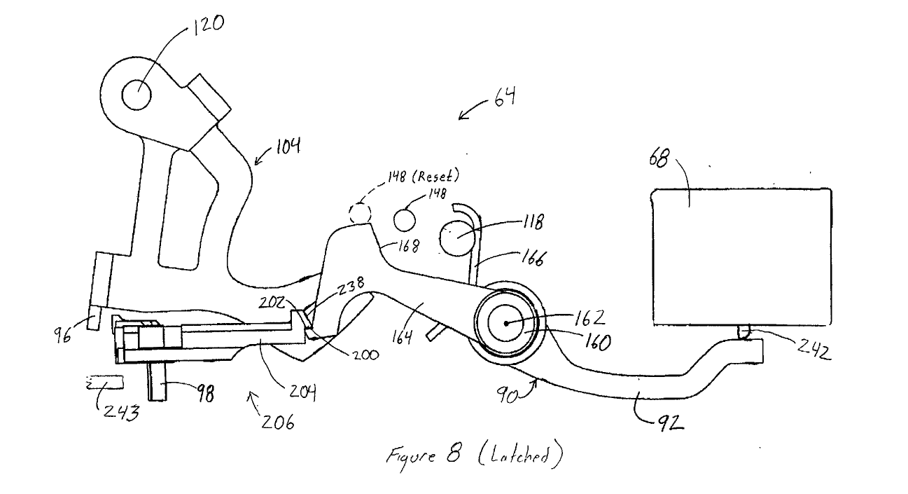

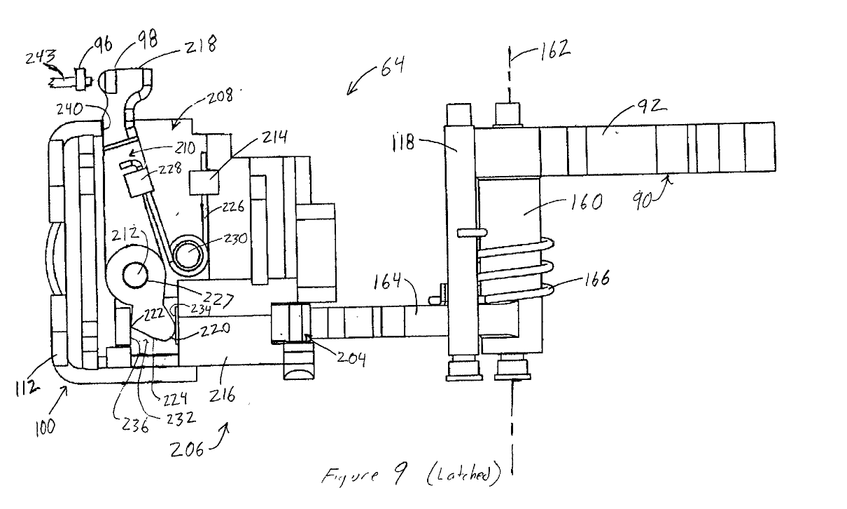

Referring to FIGS. 8 and 9, the indicator mechanism 64 is shown in the latched state. In the latched state, torsional spring 166 biases lever 90 in a clockwise direction with respect to longitudinal axis 162. Rotation of lever 90 is restrained by contact between a surface 200 formed on release arm 164 and a surface 202 formed on a slide 204. Slide 204 forms part of a latch assembly 206 of indicator mechanism 64, which is best shown in FIG. 9.

Latch assembly 206 includes a base 208, a latch lever 210, and slide 204. Base 208 is a generally flat structure attached to back wall 112 of frame 100. Extending from base 208 is a pin 212 and a spring retaining tab 214. Also extending from base 208 is a generally rectangular housing 216, which retains slide 204 and allows slide 204 to translate in a direction parallel to a longitudinal axis of slide 204.

Latch lever 210 includes indicator actuating paddle 98 disposed on an end 218, and latching and unlatching shoulders 220, 222 disposed on an opposite end 224. An aperture 227 extends through latch lever 210 and is positioned intermediate ends 218 and 224. Aperture 227 accepts pin 212, pivotally securing latch lever 210 to base 208. Latch lever 210 is biased in a counter-clockwise direction about pin 212 (with respect to the view shown in FIG. 9) by a spring 226 that extends from spring retaining tab 214 on base 208 to a spring retaining tab 228 attached to latch lever 210. The latch spring 226 is located axially by a projection 230 in base 208.

Slide 204 is slidably retained in housing 216 and includes a recess 232 formed therein for accepting end 224 of latch lever 210. On one side of recess 232, a latching surface 234 is formed, and on the other side of recess 232, an unlatching surface 236 is formed. Latching surface 234 of slide 204 interfaces with latching shoulder 220 of latch lever 210, and unlatching surface 236 of slide 204 interfaces with unlatching shoulder 222 of latch lever 210. Surface 202 is formed on an end of slide 204 proximate release arm 164. Also formed on slide 204 adjacent to surface 202 is an angled reset surface 238.

In the latched state shown in FIGS. 8 and 9, the force of spring 226 on latch lever 210 creates a moment about pin 212 that forces latching shoulder 220 into contact with latching surface 234, biasing slide 204 towards release arm 164 and maintaining contact between surface 202 on slide 204 and surface 200 on release arm 164. Latch lever 210 contacts a surface 240 formed on base 208 to prevent further rotation of latch lever 210 by spring 226. In the latched state, actuating arm 92 of lever 90 holds a functioning end 242 of accessory 68 in a first state, which in this embodiment is a retracted position. It will be recognized, however, that lever 90, spring 166 and slide 204 can be configured such that, when in the latched state, actuating arm 92 holds the functioning end 242 of accessory 68 in an extended position.

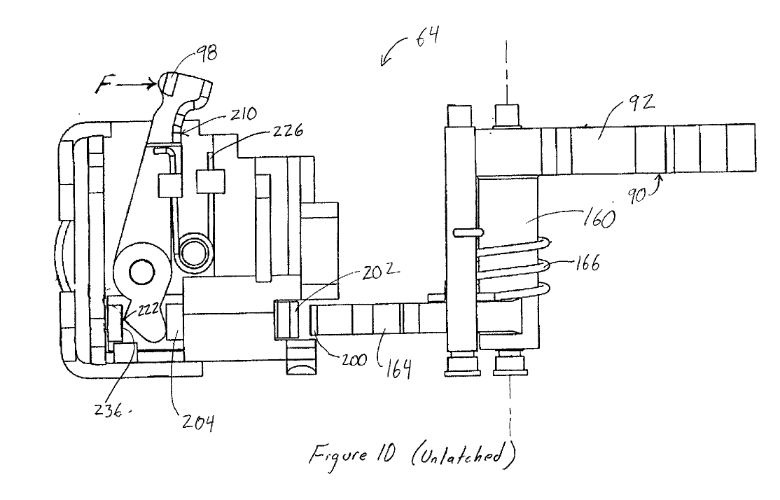

The application of an actuating force, as indicated at “F” in FIG. 10, to actuating paddle 98 actuates the indicator mechanism 64. The actuating force F is provided either by the rotation of trip arm 104 or by another device 243 for unlatching operating mechanism 14 (FIG. 2). Device 243 includes, for example, a ground fault detection device (not shown) that provides an actuating force F upon the detection of a ground fault or a trip override device (not shown) that provides an actuating force F upon an instantaneous overcurrent in any one of the phases of the electrical distribution circuit.

Referring to FIGS. 8, 9, and 10, actuating force F acting on paddle 98 rotates latch lever 210 in a clockwise direction around pin 212 and against the force of spring 226. Rotation of latch lever 210 causes unlatching shoulder 222 to contact unlatching surface 236 and forces slide 204 in a direction away from release arm 164. As slide 204 moves away from release arm 164, surface 200 disengages surface 202, allowing lever 90 to rotate in a clockwise direction (with respect to the view of FIG. 8) under the force of spring 166. The actuating arm 92 portion of lever 90 rotates away from accessory 68 allowing the functioning end 242 of accessory 68 to move to a second state, which in this embodiment is an extended position. Indicator mechanism 64 comes to rest in an unlatched state shown FIG. 10. It will be recognized that lever 90, spring 166 and slide 204 can be configured such that, when in the unlatched state, actuating arm 92 holds the functioning end 242 of accessory 68 in an retracted position.

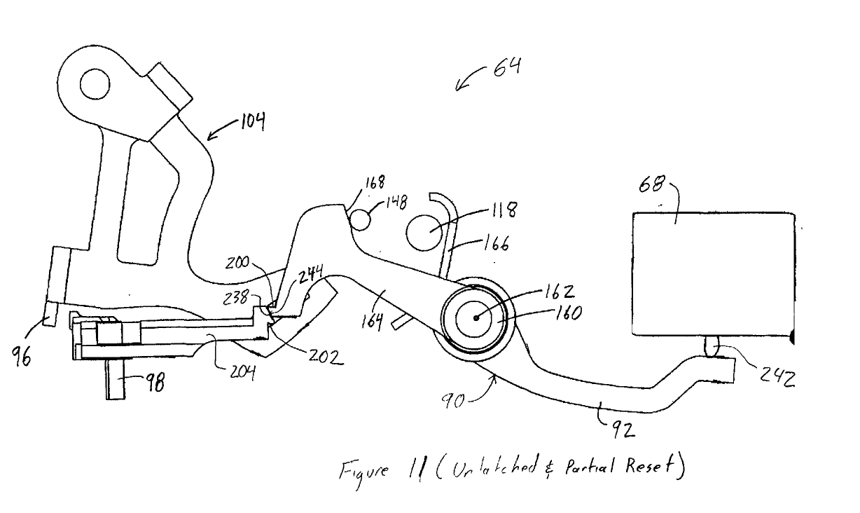

After actuating force F is removed, slide 204 will move to the position shown in FIG. 9 under action of the latch lever 210 and spring 226, allowing indicator mechanism 64 to be reset (i.e. placed in the latched and ready to operate state of FIGS. 8 and 9). Indicator mechanism 64 is reset by the motion of operating handle 18, as described herein with reference to FIGS. 5, 6, and 7. As operating handle 18 (FIG. 4) is rotated to the “RESET” position, pin 148 (FIG. 5) rides along camming surface 168. As shown in FIG. 11, lever 90 is rotated in a counter-clockwise direction around axis 162 by pin 148. Rotation of lever 90 will place a surface 244 of release arm 164 in contact with surface 238 of slide 204. Surfaces 238 and 244 are angled with a geometry that facilitates the movement of slide 204 away from release arm 164 and against the action of the latch lever 210 and spring 226. As pin 148 continues to rotate lever 90, surfaces 238 and 244 disengage and slide 204 is free to move towards latch arm 164 under the force of latch lever 210 and spring 226. This motion of slide 204 towards latch arm 164 establishes the interaction between surfaces 200 and 202, which will again prevent rotation of lever 90 by spring 166. The rotation of lever 90 by pin 148 also acts to move actuating arm 92 towards functioning end 242 of accessory 68, placing functioning end 242 in a compressed state.

The indicator mechanism 64 described herein actuates an accessory 68 in response to receiving an actuating force F, whether the actuating force F is provided from the trip arm 104 of trip actuator 66 or from any other device 243 that unlatches the operating mechanism 14. Because the indicator mechanism 64 can accept an actuating force F from more than one mechanism, the accessory 68 will indicate that the main contacts have been opened due to an electrical fault condition, regardless of the mechanism used to unlatch the operating mechanism 14 in response to that fault condition (e.g., the trip actuator 66, a ground fault detection device, or a trip override device).

In addition, the indicator mechanism 64 described herein requires only that the actuating force F be enough to unlatch lever 90 from latch assembly 206. Indicator mechanism 64 does not require the trip actuator 66 or other device 243 to provide the relatively greater force required to change the state of accessory 68. Because the indicator mechanism 64 does not rely on the actuating force of the trip actuator 66 or other device 243 to change the state of the accessory 68, the force available for unlatching the operating mechanism 14 is increased from that previously available in the prior art. As a result, the time delay from detection of an overcurrent condition to the separation of the main contacts is decreased.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A trip actuator for unlatching a circuit breaker operating mechanism and for changing a state of a circuit breaker accessory, the trip actuator comprising:
a trip arm configured to provide an actuating force for unlatching the circuit breaker operating mechanism; and
an actuator mechanism for changing the state of the circuit breaker accessory, the actuator mechanism including:
a first lever biased to rotate in a first direction about a first axis, and a latch assembly including:
a second lever, and
a slide operably coupled to said second lever, said slide releasably restrains said first lever; and
wherein application of said actuating force to said second lever positions said slide to release said first lever.

2. The trip actuator of claim 1, further comprising:
a reset lever operably coupled to the operating mechanism, said reset lever including a reset pin disposed thereon; and
wherein said first lever includes a camming surface formed thereon, said reset pin contacts said camming surface, and said first lever rotates about said axis in a direction opposite said first direction under the force of said reset pin.

3. The trip actuator of claim 2, wherein said first lever forces said slide in a direction away from said first lever as said first lever rotates about said axis in said direction opposite said first direction.

4. The trip actuator of claim 1, further including:
a frame, said trip arm is pivotally attached to said frame; and
wherein said actuator mechanism further includes:
a base secured to said frame, said base including
a generally flat surface,
a pin extending from said generally flat surface, said pin pivotally retaining said second lever, and
a housing disposed on said generally flat surface, said housing slidably retaining said slide.

5. The trip actuator of claim 4, wherein said first lever includes:
an axle pivotally attached to said frame;
a first arm extending from said axle, said first arm is releasably coupled to said slide; and
a second arm extending from said axle, said second arm is positioned proximate to the circuit breaker accessory.

6. The trip actuator of claim 1, wherein
said slide includes a latching surface and an unlatching surface formed thereon,
said second lever includes a latching shoulder and an unlatching shoulder formed thereon, and
wherein said second lever is movable between a first position and a second position, said latching shoulder contacts said latching surface in said first position and said unlatching shoulder contacts said unlatching surface in said second position.

7. A circuit breaker including:
a housing;
an operating mechanism positioned within said housing, said operating mechanism including a latch, said latch is movable between a latched position and an unlatched position;
an accessory positioned within said housing;
a trip actuator positioned within said housing, said trip actuator including:
a trip arm configured to provide an actuating force for moving said latch from
said latched position to said unlatched position, and
an actuator mechanism configured to change a state of said accessory, said actuator mechanism including:
a first lever biased to rotate in a first direction about a first axis, rotation of said first lever in said first direction changes the state of said accessory, and
a latch assembly releasably retaining said first lever; and
wherein application of said actuating force to said latch assembly releases said first lever to rotate in said first direction about said first axis.

8. The circuit breaker of claim 7, wherein said latch assembly includes:
a second lever;
a slide operably coupled to said second lever, said slide releasably restrains said first lever, and application of said actuating force to said second lever positions said slide to release said first lever.

9. The circuit breaker of claim 7, wherein said trip actuator further includes:
a reset lever operably coupled to the operating mechanism, said reset lever including a reset pin disposed thereon; and
wherein said first lever includes a camming surface formed thereon, said reset pin contacts said camming surface, and said first lever rotates about said axis in a direction opposite said first direction under the force of said reset pin.

10. The circuit breaker of claim 8, wherein said first lever forces said slide in a direction away from said first lever as said first lever rotates about said axis in a direction opposite said first direction.

11. The circuit breaker of claim 8, wherein said trip actuator further includes:
a frame, said trip arm is pivotally attached to said frame; and
wherein said actuator mechanism further includes:
a base secured to said frame, said base including
a generally flat surface,
a pin extending from said generally flat surface, said pin pivotally retaining said second lever, and
a housing disposed on said generally flat surface, said housing slidably retaining said slide.

12. The circuit breaker of claim 11, wherein said first lever includes:
an axle pivotally attached to said frame;
a first arm extending from said axle, said first is releasably coupled to said slide; and
a second arm extending from said axle, said second arm is positioned proximate to said accessory.

13. A trip actuator for unlatching a circuit breaker operating mechanism and for changing a state of a circuit breaker accessory, the trip actuator comprising:
a lever;
means for releasably restraining said lever; and
means for providing an actuating force to unlatch the circuit breaker operating mechanism, wherein application of said actuating force to said latch means releases said lever to change the state of the circuit breaker accessory.
